(19) United States
(12) Patent Application Publication
(10) Pub. No.: US 2016/0106264 A1
(43) Pub. Date: Apr. 21, 2016

(54) VERFAHREN UND KUECHENMASCHINE ZUM ZUBEREITEN EINES ZUBEREITUNGSGUTS

(71) Applicant: VORWERK & CO. INTERHOLDING GMBH, Wuppertal (DE)

(72) Inventor: Markus CORNELISSEN, Bornheim (DE)

(73) Assignee: VORWERK & CO. INTERHOLDING GMBH, Wuppertal (DE)

(21) Appl. No.: 14/887,602

(22) Filed: Oct. 20, 2015

(30) Foreign Application Priority Data
Oct. 21, 2014 (DE) 10 2014 115 346.4

(51) Int. Cl. A47J 43/08; A47J 43/046

(52) U.S. Cl. CPC A47J 43/085; A47J 43/046

(57) ABSTRACT

The invention initially relates to a method for preparing a food (4) by means of a kitchen appliance, which is driven by electric motor, wherein a food (4) contained in a mixing vessel (3) of the kitchen appliance is processed, in particular comminuted, by means of a mixer (2), which is preferably embodied as set of blades. For an advantageous improvement, in particular with regard to an improved processing success, it is proposed for the mixer (2), in a preparation phase, which precedes the processing of the food (4), to be moved into a second direction of rotation, which is opposite to a first direction of rotation (y) provided for processing the food (4), wherein the mixer (2) is subsequently moved into the first direction of rotation for processing the food (4) in a work phase. The invention furthermore relates to a kitchen appliance

The invention initially relates to a method for preparing a food by means of a kitchen appliance, which is driven by electric motor, wherein a food contained in a mixing vessel of the kitchen appliance is processed, in particular comminuted, by means of a mixer, which is preferably embodied as set of blades.

It is known in the prior art to use kitchen appliances, which are driven by electric motor, for preparing food and in particular also for comminuting a food. A set of blades arranged in a mixing vessel of the kitchen appliance is thereby rotated continuously and comminutes the food portions, which reach into the engagement area of the set of blades.

It is furthermore also known in the prior art to use the mixer of a kitchen appliance for other processing steps. For example, the publication WO 95/29614 A1 discloses a kitchen appliance, the mixer of which is used for mixing dough. A mixer setting (dough mixing switch) is provided thereby, in which program-controlled mixing phases are interrupted by periodic standstills.

The disadvantage of the methods known to date in the prior art is that the food, which is to be processed, is periodically also moved in response to the movement of the blade or—in particular a food comprising a low mass density, such as herbs—is swirled up. A processing of the food, in particular a comminution thereof, is then not possible any longer, because the food either rotates with the rotating mixer or leaves the engagement area of the mixer due to the swirl created in the mixing vessel.

It is thus the object of the invention to create a method for preparing a food, in particular for comminuting a food, which, on the one hand, improves the processing success and which, on the other hand, is also suitable for food, which can be swirled up easily, such as herbs, for example. Ideally, the processing result in the case of a comminution is to correspond to the result, which follows when the food is comminuted manually on a cutting base by means of a knife.

To solve the afore-mentioned object, the invention proposes for the mixer, in a preparation phase, which precedes the processing of the food, to be moved into a second direction of rotation, which is opposite to a first direction of rotation provided for processing the food, wherein the mixer is subsequently moved into the first direction of rotation for processing the food in a work phase.

According to the invention, the mixer is moved in a program-controlled manner in a predetermined sequence and time as well as at a predetermined speed in two opposite directions of rotations during the preparation of a food. A rotation of the mixer in a direction, which is opposite to a direction of rotation of the subsequent work phase, is thereby carried out prior to the actual processing of the food, that is, for example prior to a comminution of the food. If the mixer rotates clockwise, for example, in the work phase, a counter-clockwise rotation takes place in the preparation phase. The rotation during the preparation phase serves the purpose of creating an area, which is free from food, between at least a partial area of the mixer and the food, which is contained in the mixing vessel. The partial area of the mixer can be a cutting edge of a set of blades, for example. The cutting edge is thereby rotated opposite to its typical cutting direction, wherein a pile of food is formed on the side of the blade facing away from the cutting edge and a clearance, which is free from food portions, is created on the side of the blade, which faces the cutting edge of the blade. The size of the food pile, which is created, and of the clearance is thereby a function of the number of blades, the angular area of the rotation during the preparation phase and the material characteristics of the food. In the work phase, which follows the preparation phase, the set of blades is rotated in cutting direction, that is, in the first direction of rotation, wherein the cutting edge comes into contact with the piled up food only after overcoming the clearance, which is free from food, and comminutes it. The method according to the invention is thus similar to the manual cutting of resting food portions on a cutting base. The cutting result is thus improved as compared to the comminution processes known in the prior art in the case of kitchen appliances. The significant advantage is that the food, which is to be comminuted, is not moved along in response to an acceleration of the mixer, but that the mixer is first accelerated without contact to the food, which is to be comminuted, and meets the food, which is to be comminuted, only after a certain period of time. In terms of the invention, the processing of the food cannot only be a comminution by means of a cutting edge of a blade, but, for example, also other processing types, such as stirring, kneading, etc. Likewise, the processing of a food by means of a blunt blade side, which faces away from the cutting edge of the blade and by means of which a crushing rather than a cutting of the food can be attained, for example, is also possible.

The mixer, which is embodied as set of blades, can be a set of blades, which is described in published application DE 102 12 029 A1, for example. This set of blades has two blades, which are fastened to a common central axis of rotation so as to be offset by 90 degrees. Each of the two blades has two sickle-shaped end sections, which are located opposite one another with reference to the axis of rotation and which, in the direction of rotation, in each case have a cutting edge on one side and a kneading front on another side. Depending on the direction of rotation of the set of blades, a processing of a food can thus either be carried out by means of the cutting edge or by means of the kneading front. In a work phase, the set of blades is rotated in a direction, for example, in which the cutting edge of an end section runs ahead of the kneading front of the same end section, while in a preparation phase, the set of blades rotates in a direction, in which the kneading front runs ahead of the cutting edge. The fact that the kneading front runs ahead during the preparation phase has the advantage, in particular, that the food can be displaced by means of a contact surface, which is located at right angles to the direction of rotation and which is larger than this is the case with a cutting edge. On principle, however, both sides of the end sections can also be embodied similarly, that is, they can both be embodied as cutting edge or both as kneading front. In terms of the invention, the term cutting edge refers to a blade, which is sharpened by means of grinding, wherein the cutting edge tapers in the direction of rotation and has a thickness of maximally 0.6 mm at the thinnest location in the direction of rotation. In contrast, a kneading front has a contact surface comprising a width of at least 1 mm, which acts in the direction of rotation. This width thereby refers to a projection of the surface of the kneading front in the direction of rotation and can, on the one hand, be provided by means of a kneading front, which is perpendicular to the direction of rotation, but, on the other hand, also by means of a kneading front, the width of which increases in a direction opposite to the direction of rotation, up to a predetermined maximum width. An inclination, in the case of which the maximum width of the kneading front is reached after a maximum distance of 1 mm opposite to the direction of rotation, is advisable. The thicknesses in each case refer to a partial area of the cutting edge or of the kneading front, respectively, which has at least 30% of the length of the end section in longitudinal extension of the blade end section (radial direction in relation to the axis of rotation of the blade).

It is proposed for the mixer to stand still between a work phase and a preparation phase during a resting phase, which follows the work phase. The resting phase can thereby substantially last until the food, which is contained in the mixing vessel, does not move any longer. The use of a resting phase after the work phase is in particular suitable in the case of food, which can be swirled up easily, which rises in response to the rotation of the mixer due to the air flows, which form in the mixing vessel, and which thus leaves the reach of the mixer. A food, which might possibly be swirled up in the mixing vessel, can thus sink to the bottom of the mixing vessel during the resting phase, that is, prior to passing through a further preparation phase, and can thus come into contact with the mixer. The duration of the resting phase is a function of the type of the food. Particularly light food, such as herbs, for example, require a longer duration to sink to the mixing vessel bottom than small pieces of meat, for example, which are swirled up. It is proposed for the resting phase—depending on the type of the food—to have a duration of between approximately 0.1 seconds and 10 seconds, in particular between 0.5 seconds and 3 seconds. The longer duration is thereby in each case provided for lighter food. The resting phase starts with the standstill of the mixer and ends in the moment, in which the food rests substantially completely on the bottom of the mixing vessel. A state, in which the food does no longer move in vertical as well as in horizontal direction, is thereby desired, wherein it is paramount for the processing success of the method that the food is located within the engagement area of the mixer. States, in which the food does not yet rest completely, but is already located in the engagement area of the mixer, also fall under the term “no longer moved” in this regard.

It is furthermore proposed for the sequence of a preparation phase and of a work phase to be repeated cyclically. In the alternative, it is proposed for the sequence of a preparation phase, of a work phase, and a resting phase, to be repeated cyclically. Provision is thus made for the sequence of a preparation phase and of a work phase to not only take place once, but to be repeated several times, so that a preparation phase or first a resting phase and then a preparation phase, respectively, follows a work phase again. The requirement of passing through a resting phase between a work phase and a subsequent preparation phase, is a function of the type and characteristic of the food, which is to be processed. If the food is meat, for example, a resting phase can be foregone. However, if the food is a very light food, e.g., such as herbs, for example, it is advisable to provide for a resting phase, during which the food can sink to the bottom of the mixing vessel again after being swirled up. If the food is only subject to being swirled to a particularly small extent and thus sinks back to the bottom of the mixing vessel immediately after stopping the mixer, for example within less than 1 second, the resting phase can also be a part of the preparation phase, wherein the preparation phase might include a longer duration or a larger angular area, so that the food portions, which sink, substantially rest until the preparation phase has ended. The number of repetitions of the sequence of preparation phase and work phase or preparation phase, work phase and resting phase, respectively, depends substantially on the type of processing, the type of food and the type of mixer, which is used. On principle, provision can be made for several hundreds of cycles, so as to move the food into the desired processing state.

It is furthermore proposed for the preparation phase to have a rotation of the mixer about an angular area of between 45 degrees and 225 degrees, in particular of between 90 degrees and 180 degrees. The proposed angular area, through which the mixer passes during the preparation phase, is suitable in particular for mixers comprising processing surfaces, which are offset by between 90 degrees and 180 degrees. For example, the mixer can be a set of blades comprising four cutting edges, which are offset relative to one another at an angular distance of 90 degrees relative to one another. In response to a rotation of the mixer about an angular area of 90 degrees, exactly that angular area is thus covered, which corresponds to the distance between two blade cutting edges. In this regard, a local accumulation of all of the food portions, which are arranged within the angular area of 90 degrees, takes place during the preparation phase. If the mixer is furthermore rotated by more than 90 degrees, the food pile can be compacted further, if applicable. This depends on the consistency of the respective food. The clearance, which is created between the front side of the mixer in work direction and the food pile, simultaneously refers to the available free acceleration path of the mixer and is thus simultaneously also a measure for the speed, which the mixer can reach until coming into contact with the food.

It is proposed for the preparation phase to have a duration of between approximately 0.5 seconds and 5 seconds, in particular between 0.5 seconds and 2 seconds. In the preparation phase, the mixer is rotated into the second direction of rotation and is thus brought into the start position for the subsequent work phase. The slower the preparation phase takes place, that is, the longer the duration thereof, the lower the risk of generating swirls of air, through which particularly light food, such as herbs, for example, can be swirled up in the mixing vessel. In practice, a duration of between 0.5 seconds and 5 seconds turned out to be optimal for the preparation phase. During this time, the mixer can advantageously rotate about between 90 degrees and 180 degrees. In this context, the preparation can be shorter, the larger the mass of the food portions, which are present in the mixing vessel.

Provision is made for the work phase to have a rotation of the mixer about an angular area of between 360 degrees once and five times 360, in particular of between 360 degrees once and three times 360 degrees. According to the invention, the rotation takes place during the work phase, that is, the rotation into the first direction of rotation, via a larger angular area than the rotation during the preparation phase, that is, the rotation into the second direction of rotation. On principle, the number of rotations of the mixer is not limited for each work phase. To avoid an undesirable swirling of food portions, it is advisable, however, to limit the number of rotations, advantageously to up to five complete rotations, that is, up to five times 360 degrees. In particular, a one-time or three-time rotation is advisable, before a further preparation phase and/or resting phase follows, if applicable.

Preferably, the level of the rotational speed of the mixer is larger in the work phase than in the preparation phase, preferably at least ten times as large to maximally one thousand times as large. The invention thus accommodates the knowledge that particularly low rotational speeds are advisable in the preparation phase, while a rotational speed, which is as high as possible, is advantageous in the work phase. For example, a complete revolution of the mixer in the preparation phase, that is, into the second direction of rotation, can take 10 seconds, while it takes only one hundredth of a second or less in the work phase. In particular, the speed of the mixer in the work phase can be more than ten thousand revolutions per minute.

It is furthermore proposed for the resting phase to have a duration of between approximately 0.1 seconds and 10 seconds, in particular between 0.5 seconds and 3 seconds. In this regard, a duration of between approximately 0.1 seconds and 10 seconds is available after the mixer is stopped and a new rotation of the mixer, during which the food, which is to be processed, which might have been swirled up in the mixing vessel, can drop to the bottom of the mixing vessel again. The required resting phase thereby varies, depending on the characteristics, in particular the mass, of the individual food portions, wherein the resting phase can be shorter, the heavier a food portion, for example a basil leaf or a small piece of meat.

In addition to the above-presented method for preparing a food, a kitchen appliance comprising a mixing vessel, a mixer preferably embodied therein as set of blades, an electric motor for rotating the mixer and a motor control for controlling the electric motor is proposed, wherein the motor control is set up to control the electric motor in such a manner that, in a preparation phase, which precedes a processing of a food, the mixer is moved into a second direction of rotation, which is opposite to a first direction of rotation, which is provided for processing the food, wherein the mixer is subsequently moved into the first direction of rotation for processing the food in a work phase.

The kitchen appliance according to the invention thus has a motor control, which can control the mixer to carry out the method according to the invention. In particular, the motor control is set up to control a preparation phase, a work phase and a resting phase, if applicable, in chronological order, so that a food, which is contained in the mixing vessel, can be comminuted optimally. The features specified above in connection with the method according to the invention, also apply analogously for the kitchen appliance, which carries out the method.

The invention will be specified below in more detail by means of an exemplary embodiment:

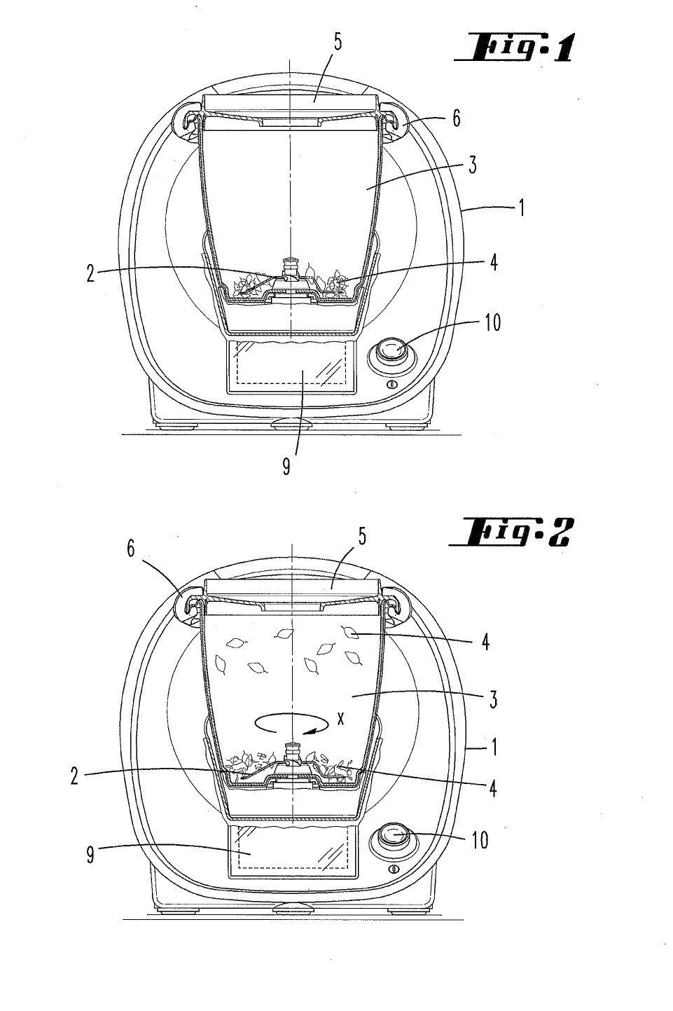

FIG. 1 shows a front view of a kitchen appliance according to the invention,

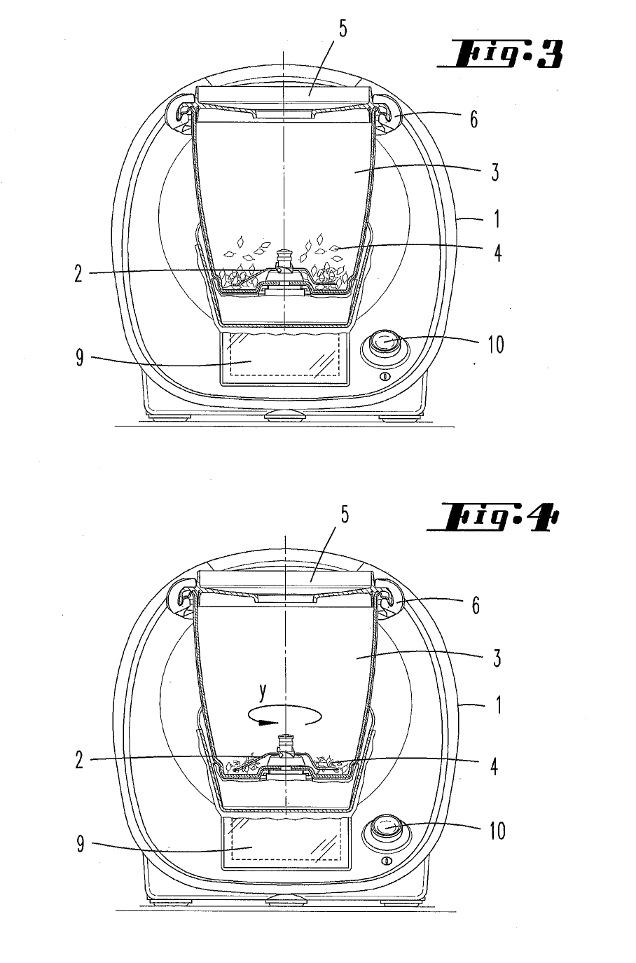

FIG. 2 shows the kitchen appliance according to FIG. 1 during a work phase,

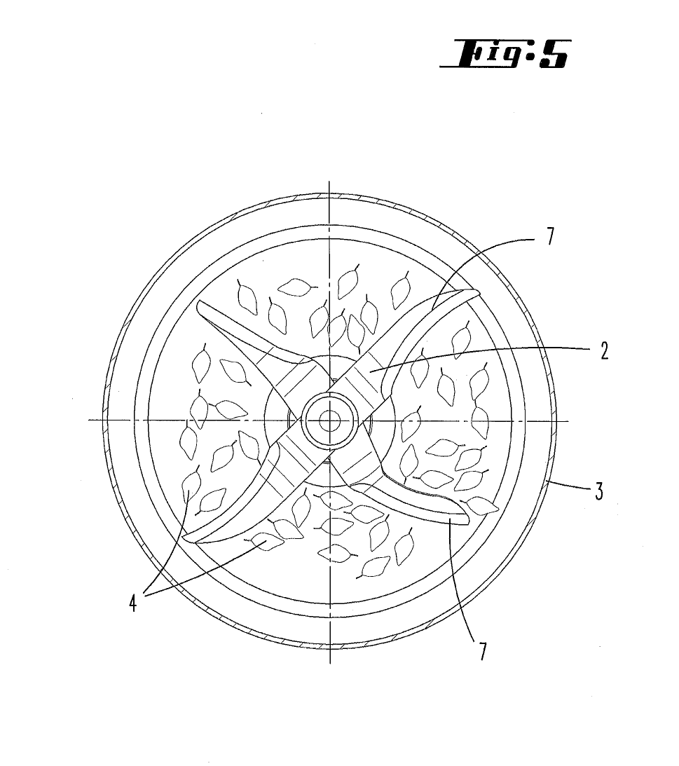

FIG. 3 shows the kitchen appliance according to FIG. 1 during a resting phase,

FIG. 4 shows the kitchen appliance according to FIG. 1 during a preparation phase,

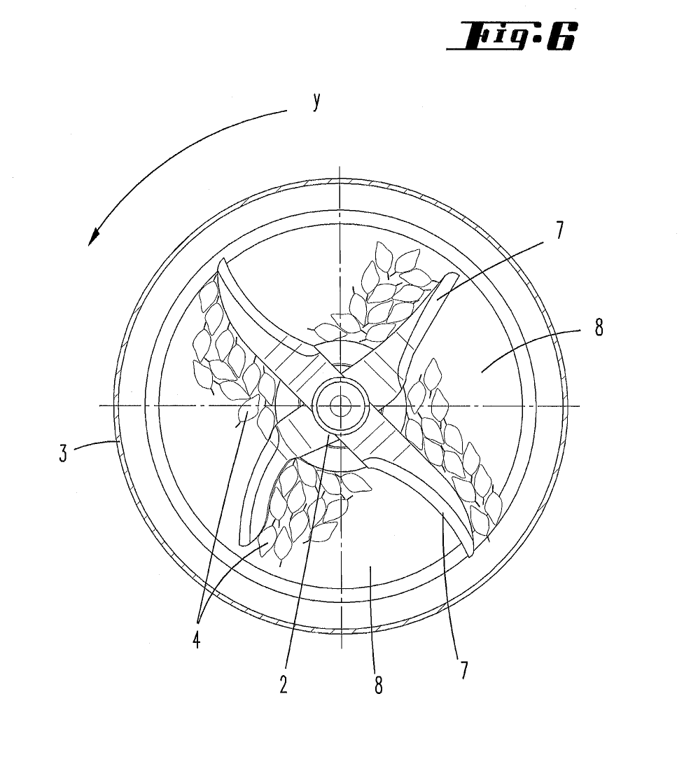

FIG. 5 shows a view into a mixing vessel from the top,

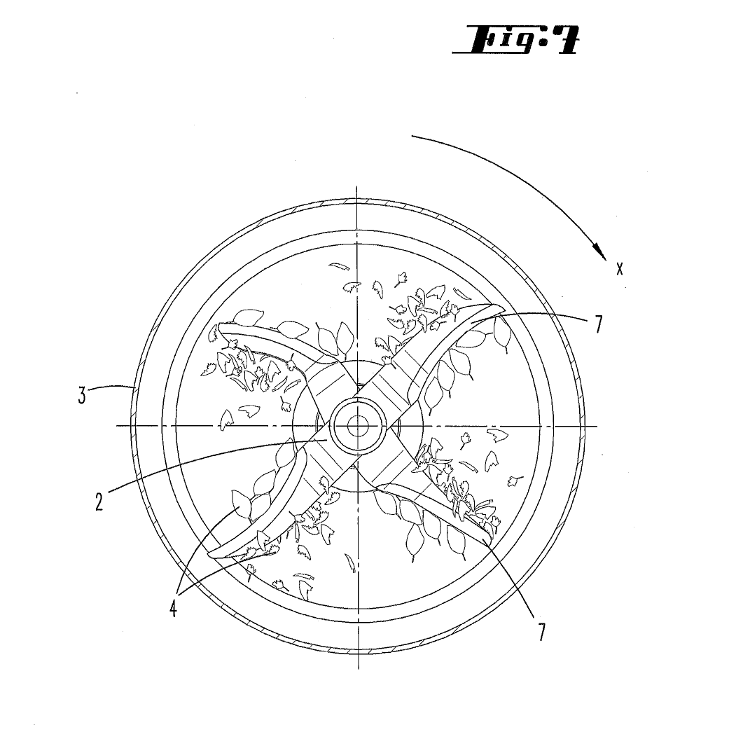

FIG. 6 shows the mixing vessel according to FIG. 5, directly after a preparation phase,

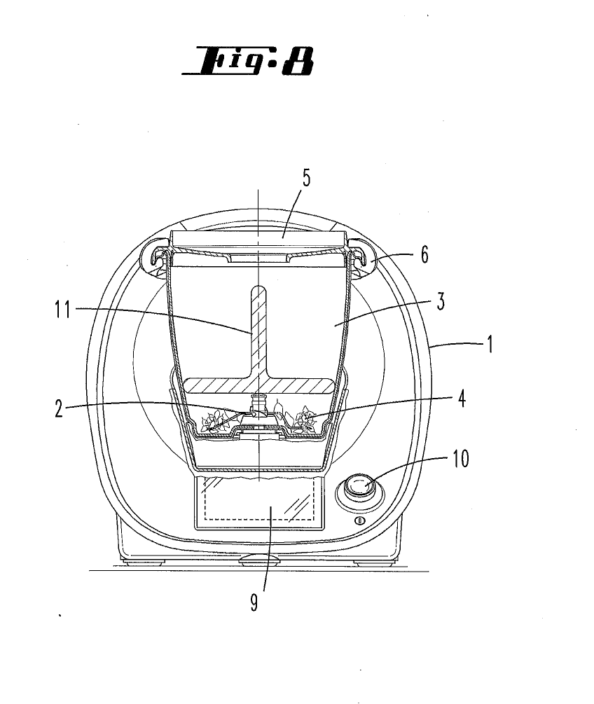

FIG. 7 shows the vessel according to FIG. 5 during a work phase,

FIG. 8 shows a front view of a kitchen appliance according to a further embodiment alternative.

The kitchen appliance 1 illustrated in FIGS. 1 to 4 has a mixing vessel 3, in which a mixer 2, embodied herein as set of blades, is arranged. The mixing vessel 3 is closed by means of a lid 5. Mixing vessel 3 and lid 5 are locked by means of two locking elements 6, preferably embodied herein as locking rollers. In a common manner, the kitchen appliance 1 additionally has a display 9 and a switch 10 for controlling the device functions or for turning the kitchen appliance 1 on and off, respectively. The kitchen appliance 1 can furthermore have further devices for preparing food. For example, this includes a heating device (not illustrated) or the like.

A food 4, which is to be processed by means of the mixer 2 of the kitchen appliance 1, is arranged in the mixing vessel 3. As illustrated, the food 4 are basil leaves, for example. The food 4 is located in the bottom area of the mixing vessel 3, that is, simultaneously also in the engagement area of the mixer 2, so that the food 4 can come into contact with the processing surfaces of the mixer 2 in response to a rotation of the mixer 2.

During a work phase illustrated in FIG. 2, the mixer 2 rotates into a first direction of rotation x. The first direction of rotation x is thereby a clockwise direction of rotation. As illustrated in FIG. 2, the food 4 is swirled up inside the mixing vessel 3 during the work phase in the case of particularly light food 4, such as basil, for example, here, whereby a portion of the food 4, which is to be processed, is no longer located in the engagement area of the mixer 2. This portion of the food 4 is withheld from being processed by the mixer 2 in this regard. Instead of particularly light food 4 in terms of the invention, in the case of which the individual food portions, that is, the basil leaves herein, have a smaller mass and are thus subject to being swirled to an increased extent, the food 4 can instead also be food 4 comprising a larger mass per food portion. For example, the food 4 can be a lumpy mixture, such as, for example, small individual pieces of meat of a partially comminuted piece of meat, as it occurs when preparing “ragout”, for example.

FIG. 3 shows the kitchen appliance 1 during a resting phase according to the invention, in which the mixer 2 stands and the food portions, which might have been swirled up, can sink to the bottom of the mixing vessel 3.

FIG. 4 shows the kitchen appliance 1 during a subsequent preparation phase, during which the mixer 2 moves into a second counter-clockwise direction of rotation y.

The invention works as illustrated in FIG. 2 to 4 or 5 to 7, respectively. On principle, the method can thereby be started in a state, in which the food 4 is already located completely on the bottom of the mixing vessel 3, or for example directly after filling the food 4 into the mixing vessel 3. In the alternative, the method can also be a cycle of a plurality of cycles during a preparation of the food 4. In the latter case, the method is described based on the work phase illustrated in FIG. 2.

According to FIG. 5, a food 4 is located inside the mixing vessel 3. The food 4 consists of a plurality of food portions, here a plurality of individual basil leaves. For example, the illustrated state can occur immediately after a work phase or a resting phase has ended, in which the mixer 2 stands still, that is, prior to a subsequent preparation phase. During the resting phase, a portion of the food 4 can still be swirled up inside the mixing vessel 3—as illustrated in FIG. 3, for example. In this case, the resting phase is continued, until the food 4 has reached substantially completely into the engagement area of the mixer 2.

Based on the state illustrated in FIG. 5, the mixer 2 is moved into a second direction of rotation y during the preparation phase illustrated in FIG. 6. This second direction of rotation y relates to a counter-clockwise direction of rotation, wherein the side, which faces away from a cutting edge 7 of the mixer 2, runs ahead in the direction of rotation y. This preparation phase serves the purpose of arranging the food 4, which is arranged in the mixing vessel 3, in food piles, wherein a clearance 8 forms in each case between a cutting edge 7 of the mixer 2 and a pile of food, in which no portions of the food 4 are arranged.

In the illustrated example, the mixer 2 is embodied as set of blades comprising four cutting edges 7, which are offset by 90 degrees. During the preparation phase, the mixer 2 is rotated by 90 degrees, wherein a certain partial area fills with the piled up food 4 between the cutting edges 7 of the mixer 2 due to the quantity of the food 4. The remaining area forms the clearance 8. During a subsequent work phase, this clearance 8 serves as acceleration path for the cutting edges 7. The work phase is illustrated in FIG. 7.

During the work phase illustrated in FIG. 7, the mixer 2 and thus also the cutting edges 7, are moved into a first direction of rotation x, here in clockwise direction. The mixer 2 thereby rotates first through the clearance 8, in which a contact does not yet take place between the cutting edges 7 and the food 4. The clearance 8 is thus used to accelerate the mixer 2 to a rotational speed, which is suitable to comminute the food 4. As soon as the clearance 8 of the area 12 has been passed through, the food 4 comes into contact with the cutting edges 7 and is at least partially comminuted. The work phase can thereby have a plurality of revolutions of the mixer 2, for example a rotation about an angular area of 360 degrees once to five times 360 degrees. Depending on the type of the food 4, which is to be processed, a different number of revolutions for each work phase may be appropriate. If it is a particularly light food 4, as in the illustrated exemplary embodiment, a portion of the food 4 is swirled up in the mixing vessel 3. It is thus advisable for the number of the revolutions per work phase to not be too high in these cases.

Advantageously, a resting phase (see FIG. 3), in which portions of the food 4, which might have been swirled up in the mixing vessel 3, drop to the bottom of the mixing vessel 3 again, can follow the work phase, which is illustrated in FIG. 7. The resting phase can thereby take between a fraction of a second and several seconds, depending on the type of the food, before a further cycle of the method according to the invention can be started. If desired, a further cycle of preparation phase, work phase and resting phase then follows.

If the food 4, which is to be processed, is food 4 comprising a larger mass, for example small pieces of meat, the resting phase can be foregone, if applicable, or can be integrated into the preparation phase. In this case, a preparation phase can connect directly to a work phase, wherein portions of the food 4, which might still be swirled up, drop to the bottom of the mixing vessel 3 during the preparation phase and are arranged to form a food pile prior to the onset of the subsequent work phase. If applicable, the duration of the preparation phase can be extended and/or the angular area passed through during the preparation phase can be enlarged for this purpose.

FIG. 8 shows an embodiment alternative of the invention, according to which an intermediate lid 11 is inserted into the mixing vessel 3. The intermediate lid 11 rests against the curved wall inside the mixing vessel 3 and is thus held in position. The space, which is available for the food 4 inside the mixing vessel 3, is reduced by means of the intermediate lid 11, so that food 4, which is swirled up easily in response to a rotation of the mixer 2, can only be swirled up to the bottom side of the intermediate lid 11. A resting phase can thus be shortened or can even be foregone completely during the preparation phase.

Advantageously, the intermediate lid 11 has a grip, handle or the like for a comfortable insertion into or removal from the mixing vessel 3, respectively. Provision can also be made for latching means, by means of which the intermediate lid 11 is held in position inside the mixing vessel 3—also during the operation of the mixer 2.

### LIST OF REFERENCE NUMERALS

1 kitchen appliance
2 Mixer
3 mixing vessel
4 Food
5 Lid
6 locking element
7 cutting edge
8 clearance
9 Display
10 switch
11 intermediate lid
x direction of rotation
y direction of rotation

1: A method for preparing a food (4) by means of a kitchen appliance (1), which is driven by electric motor, wherein a food (4) contained in a mixing vessel (3) of the kitchen appliance (1) is processed, in particular comminuted, by means of a mixer (2), which is preferably embodied as a set of blades, wherein in a preparation phase, which precedes the processing of the food (4), the mixer (2) is moved into a second direction of rotation (y), which is opposite to a first direction of rotation (x) provided for processing the food (4), wherein the mixer (2) is subsequently moved into the first direction of rotation (x) for processing the food (4) in a work phase.

2: The method according to claim 1, wherein the mixer (2) stands still between a work phase and a preparation phase during a resting phase, which follows the work phase.

3: The method according to claim 1, wherein the sequence of a preparation phase and of a work phase or the sequence of a preparation phase, a work phase and a resting phase is repeated cyclically.

4: The method according to claim 1, wherein the preparation phase has a rotation of the mixer (2) about an angular area of between 45 degrees and 225 degrees, in particular of between 90 degrees and 180 degrees.

5: The method according to claim 1, wherein the preparation phase has a duration of between approximately 0.5 seconds and 5 seconds, in particular between 0.5 seconds and 2 seconds.

6: The method according to claim 1, wherein the work phase has a rotation of the mixer (2) about an angular area of between 360 degrees once and five times 360 degrees, in particular about an angular area of between 360 degrees once and three times 360 degrees.

7: The method according to claim 1, wherein the level of the rotational speed of the mixer (2) is larger in the work phase than in the preparation phase, preferably at least ten times as large to maximally one thousand times as large.

8: The method according to claim 1, wherein the resting phase has a duration of between approximately 0.1 seconds and 10 seconds, in particular between 0.5 seconds and 3 seconds.

9: A kitchen appliance (1) comprising a mixing vessel (3), a mixer (2) preferably embodied therein as a set of blades, an electric motor for rotating the mixer (2) and a motor control for controlling the electric motor, wherein the motor control is set up to control the electric motor in such a manner that; in a preparation phase, which precedes a processing of a food (4), the mixer (2) is moved into a second direction of rotation (y), which is opposite to a first direction of rotation, which is provided for processing the food (4), wherein the mixer (2) is subsequently moved into the first direction of rotation (x) for processing the food (4) in a work phase.
